(19) United States
(12) Patent Application Publication
(10) Pub. No.: US 2008/0058084 A1
(43) Pub. Date: Mar. 6, 2008

(54) Slot machine and playing method thereof

(75) Inventor: Hiroki Saito, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/892,202

(22) Filed: Aug. 21, 2007

(30) Foreign Application Priority Data
Aug. 25, 2006 (JP) JP2006-229338

(51) Int. Cl. A63F 13/00

(52) U.S. Cl. 463/20

(57) ABSTRACT

A predetermined effect image is displayed on a display. Thereafter, symbols to be arranged are determined by selecting the symbols from a plurality of symbols having different attributes. When the determined symbols are stop-displayed, the determined symbols are sequentially displayed in an arbitrary order in each display area. In this event, the already arranged symbols are blinked. The attributes of the already arranged symbols are changed from first attributes of the symbols at the time when originally arranged to second attributes during the blinking. When the symbols are finally arranged on the display, a corresponding payout is provided when there are a predetermined number or more of symbols different in size and identical in attribute, or when there are a predetermined number or more of symbols identical in attribute.

### CROSS REFERENCE TO RELATED APPLICATIONS

This application is based upon and claims the benefit of priority from the prior Japanese Patent Application No. 2006-229338, filed on Aug. 25, 2006, the entire contents of which are incorporated herein by reference.

### BACKGROUND OF THE INVENTION

1. Field of the Invention

The present invention relates to a slot machine for playing a game using game media such as coins and bills, and a playing method thereof.

2. Description of the Related Art

In a slot machine of a related art, as disclosed in U.S. Pat. No. 6,960,133 and U.S. Pat. No. 6,012,983, when a player throws game media such as medals, coins and bills into an insertion slot of the slot machine and then presses a spin button, a plurality of symbols are scroll-displayed in a display part provided on a front surface of the cabinet. Thereafter, the respective symbols are automatically stopped. In this event, when the scrolling display of the respective symbols is started by pressing the spin button, the processing of determining stop symbols is performed. When a shift to a bonus game, such as a mystery bonus and a second game, is won by the processing of determining the stop symbols, a shift is made from the basic game to the bonus game, and the bonus game is executed. Moreover, the slot machine is set to provide awards (payouts) according to a winning state generated through the progress of a game.

Conventionally, a payline for determining a combination of stop symbols is generally set to be a straight line on a plurality of mechanical reels or a video reel displayed in a liquid crystal display device. Meanwhile, slot machines configured by taking into consideration various paylines as described below other than such a straight payline are also appearing. U.S. Pat. No. 6,093,102 and U.S. Pat. No. 6,960,133 disclose slot machines including paylines not only straight ones but also others.

As disclosed in U.S. Pat. No. 6,093,102 and U.S. Pat. No. 6,960,133, in a slot machine configured to provide a payout when certain symbols are stopped on a payline in a matrix display part including a plurality of columns and rows, a combination of symbols accompanied by a payout is formed on a certain line. In this regard, as a result, the same display mode as that of the conventional machines having the straight payline is used.

### SUMMARY OF THE INVENTION

It is an object of the present invention to provide a slot machine which enables a player to have higher expectations by imparting new entertainment properties to conditions of providing payouts, and to provide a playing method thereof.

The first aspect of the present invention is a slot machine comprising: a display adapted to arrange a plurality of symbols having different sizes and different attributes; and a controller configured to (a) determine symbols to be arranged on the display from the plurality of symbols, (b) arrange the determined symbols on the display, and (c) provide a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

In the first aspect of the present invention, when a plurality of symbols having different sizes and different attributes determined by selection from the plurality of symbols are arranged on the display, a payout is provided, which corresponds to a predetermined number or more of symbols in any one of a case where there are the predetermined number or more of the symbols identical in attribute, and a case where there are the predetermined number or more of the symbols different in size and identical in attribute.

Thus, according to the first aspect of the present invention, a player can be allowed to have higher expectations by imparting new entertainment properties to conditions of providing payouts such as providing a payout with an idea different from formation of a specific combination on a so-called payline.

The second aspect of the present invention is a slot machine comprising: a display adapted to arrange a plurality of symbols having different sizes and different attributes; and a controller configured to (a) determine symbols to be arranged on the display from the plurality of symbols, (b) sequentially arrange the determined symbols in an arbitrary order in a display area of the display, and (c) provide a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

In the second aspect of the present invention, a plurality of symbols having different sizes and different attributes determined by selection from the plurality of symbols are sequentially arranged in an arbitrary order on the display, and a payout is provided when a predetermined number of the symbols are arranged on the display, the payout corresponding to a predetermined number or more of symbols in a case where there are the predetermined number or more of the symbols identical in attribute, or where there are the predetermined number or more of the symbols different in size and identical in attribute.

Thus, according to the second aspect of the present invention, a player can be allowed to have higher expectations by imparting new entertainment properties to conditions of providing payouts such as providing a payout with an idea different from formation of a specific combination on a so-called payline.

The third aspect of the present invention is a slot machine comprising: a display adapted to arrange a plurality of symbols having different sizes and different attributes; a memory storing a payout table corresponding to any one of a predetermined number or more of the symbols identical in attribute and a predetermined number or more of the symbols different in size and identical in attribute; and a controller configured to (a) determine symbols to be arranged on the display from the plurality of symbols, (b) sequentially arrange the determined symbols in an arbitrary order in a display area of the display, (c) blink the already arranged symbols, (d) change the attributes of the already-arranged symbols from first attributes originally arranged to second attributes during the blinking, (e) determine whether arrangement of the symbols is one corresponding to the payout table stored in the memory when a predetermined number of the determined symbols are arranged on the display, and (f) provide the payout corresponding to the predetermined number or more of the symbols when it is determined that the arrangement of the symbols is the one corresponding to the payout table stored in the memory.

In the third aspect of the present invention, a plurality of symbols having different sizes and different attributes determined by selection from the plurality of symbols are sequentially arranged in an arbitrary order on the display, the already arranged symbols are blinked, and the symbols are arranged after having changed the attributes of the already arranged symbols from first attributes of the symbols at the time when originally arranged to second attributes during the blinking. Moreover, when the predetermined number of the symbols are arranged on the display, it is determined whether arrangement of the symbols is one corresponding to the payout table stored in the memory. Furthermore, the payout corresponding to the predetermined number or more of the symbols is provided when the arrangement corresponding to the payout is established.

Thus, according to the third aspect of the present invention, a player can be allowed to have higher expectations by imparting new entertainment properties to conditions of providing payouts such as providing a payout with an idea different from formation of a specific combination on a so-called payline.

The fourth aspect of the present invention is a method of playing a slot machine, the method comprising the steps of: (a) arranging symbols determined from a plurality of symbols on a display adapted to arrange the plurality of symbols having different sizes and different attributes; and (b) providing a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

In the fourth aspect of the present invention, when a plurality of symbols having different sizes and different attributes determined by selection from the plurality of symbols are arranged on the display, a payout is provided, which corresponds to a predetermined number or more of symbols in a case where there are the predetermined number or more of the symbols identical in attribute, or where there are the predetermined number or more of the symbols different in size and identical in attribute.

Thus, according to the fourth aspect of the present invention, a player can be allowed to have higher expectations by imparting new entertainment properties to conditions of providing payouts such as providing a payout with an idea different from formation of a specific combination on a so-called payline.

The fifth aspect of the present invention is a method for playing a slot machine, the method comprising the steps of (a) sequentially arranging, in an arbitrary order, symbols determined from a plurality of symbols in a display area of a display adapted to arrange the plurality of symbols having different sizes and different attributes; and (b) providing a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

In the fifth aspect of the present invention, a plurality of symbols having different sizes and different attributes determined by selection from the plurality of symbols are sequentially arranged in an arbitrary order on the display, and a payout is provided when a predetermined number of the symbols are arranged on the display, the payout corresponding to a predetermined number or more of symbols in a case where there are the predetermined number or more of the symbols identical in attribute, or in a case where there are the predetermined number or more of the symbols different in size and identical in attribute.

Thus, according to the fifth aspect of the present invention, a player can be allowed to have higher expectations by imparting new entertainment properties to conditions of providing payouts such as providing a payout with an idea different from formation of a specific combination on a so-called payline.

The sixth aspect of the present invention is a method of playing a slot machine, the method comprising the steps of (a) sequentially arranging, in an arbitrary order, symbols determined from a plurality of symbols in a display area of a display adapted to arrange the plurality of symbols having different sizes and different attributes; (b) blinking the already arranged symbols; (c) changing the attributes of the already-arranged symbols from first attributes originally arranged to second attributes during the blinking; (d) determining whether arrangement of the symbols is one corresponding to a payout table stored in a memory, which stores payouts corresponding to any one of a predetermined number or more of symbols identical in attribute and a predetermined number or more of symbols different in size and identical in attribute, when a predetermined number of the determined symbols are arranged on the display; and (e) providing the payout corresponding to the predetermined number or more of the symbols when it is determined that the arrangement of the symbols is the one corresponding to the payout table stored in the memory.

In the sixth aspect of the present invention, a plurality of symbols having different sizes and different attributes determined by selection from a plurality of symbols are sequentially arranged in an arbitrary order on the display, the already arranged symbols are blinked, and the symbols are arranged after having changed the attributes of the already arranged symbols from first attributes thereof at the time when originally arranged to second attributes during the blinking. Moreover, when a predetermined number of the symbols are arranged on the display, it is determined whether arrangement of the symbols is one corresponding to the payout table stored in the memory. Furthermore, the payout corresponding to the predetermined number or more of the symbols is provided when the arrangement corresponding to the payout is established.

Thus, according to the sixth aspect of the present invention, a player can be allowed to have higher expectations by imparting new entertainment properties to conditions of providing payouts such as providing a payout with an idea different from formation of a specific combination on a so-called payline.

### BRIEF DESCRIPTION OF THE DRAWINGS

FIG. 1 is a flowchart showing a method of playing a slot machine according to an embodiment of the present invention.

FIG. 2 is a perspective view showing an appearance of the slot machine according to the embodiment of the present invention.

FIG. 3 is a view showing symbols and code numbers of the symbols, the symbols displayed in the respective display areas in the slot machine according to the embodiment of the present invention.

FIG. 4 is a view of a payout table showing a relationship between combinations and payouts established in the embodiment of the present invention.

FIG. 5 is a block diagram showing a control circuit in the slot machine according to the embodiment of the present invention.

FIG. 6 is a flowchart showing procedures of the authentication and reading processing of a game program and a game system program executed by a motherboard and a gaming board in the slot machine according to the embodiment of the present invention.

FIG. 7 is a flowchart showing procedures for processing a basic game executed in the slot machine according to the embodiment of the present invention.

FIG. 8 is a flowchart showing procedures of stop symbol determination processing executed in the slot machine according to the embodiment of the present invention.

FIG. 9 is a flowchart showing procedures of symbol scroll-display processing executed in the slot machine according to the embodiment of the present invention.

FIG. 10 is a flowchart showing procedures for processing a bonus game executed in the slot machine according to the embodiment of the present invention.

FIG. 11 is an explanatory view showing a display example of notifying that the basic game is to be started in the slot machine according to the embodiment of the present invention.

FIG. 12 is an explanatory view showing a display example when the basic game is played on the slot machine according to the embodiment of the present invention.

FIG. 13 is an explanatory view showing a display example when the basic game is played on the slot machine according to the embodiment of the present invention.

FIG. 14 is an explanatory view showing a display example when the basic game is played on the slot machine according to the embodiment of the present invention.

FIG. 15 is an explanatory view showing a display example when the basic game is played on the slot machine according to the embodiment of the present invention.

FIG. 16 is an explanatory view showing a display example when the basic game is played on the slot machine according to the embodiment of the present invention.

FIG. 17 is an explanatory view showing a display example when the basic game is played on the slot machine according to the embodiment of the present invention.

FIG. 18 is an explanatory view showing a display example when the basic game is played on the slot machine according to the embodiment of the present invention.

### DETAILED DESCRIPTION OF THE EMBODIMENT

With reference to the drawings, a slot machine according to an embodiment of the present invention will be described in detail below.

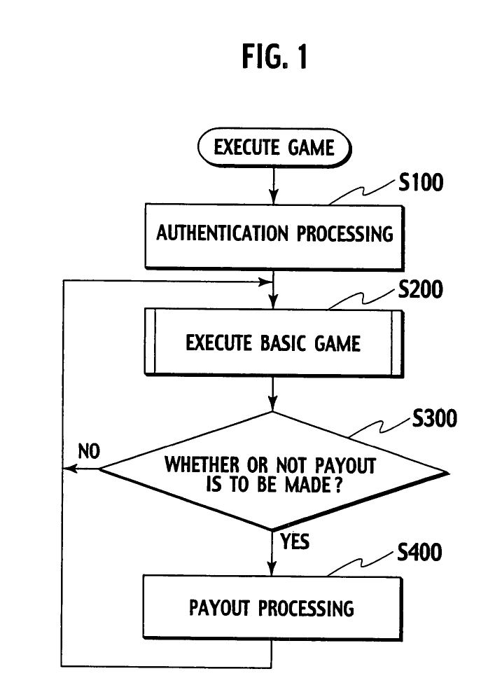

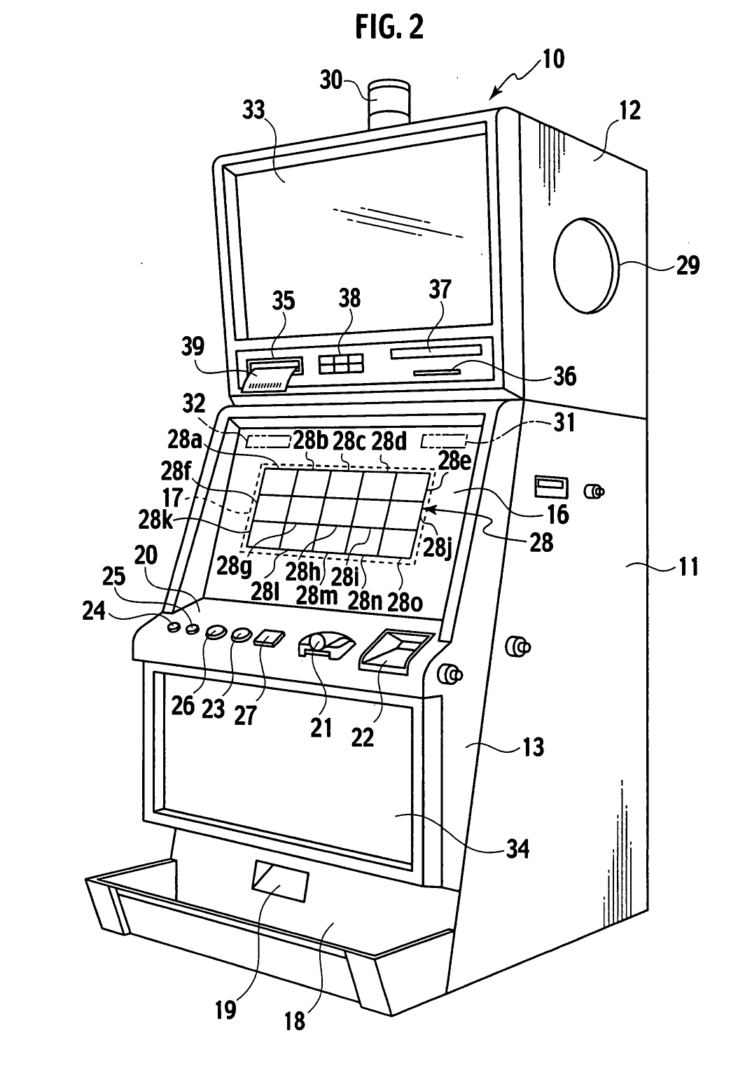

FIG. 1 is a flowchart schematically showing a method for playing the slot machine according to the embodiment of the present invention. With reference to the flowchart shown in FIG. 1 and a perspective view shown in FIG. 2, description will be given below of schematic operations of the slot machine and the method for playing the slot machine according to the embodiment of the present invention.

In the slot machine according to the embodiment of the present invention, when the power is turned on to start the slot machine, authentication processing is first performed (Step S100). In the authentication processing, initial checking before a unit game is started is carried out, such as whether or not a program for operating a system runs normally, whether or not the program has been altered, and the like.

Next, a basic game is executed (Step S200). In the basic game, the unit game is executed as described below. When a spin button 23 is pressed in a state where the desired number of credits are bet by throwing coins into a coin receiving opening 21 or the like, a predetermined effect image is displayed by using an entire display area 28 of a liquid crystal display unit 17 provided on a front surface of a cabinet 11. Thereafter, symbols are newly rearranged in 5 cells in width×3 cells in height, a total of 15 cells included in the display area 28 (28a to 28o), respectively.

In each unit game, arrangement control is carried out for arranging symbols determined by performing the processing of determining symbols to be arranged in the respective display areas 28a to 28o among a plurality of symbols having different sizes and different attributes. In this embodiment, the attribute is the colors of symbols.

This embodiment is characterized in the following point. Specifically, conditions of whether or not a payout is to be provided to a player when the symbols are arranged are not determined by whether or not a specific combination is formed on a conventional “payline”. However, the payout is provided in a case where there are the predetermined number or more of symbols having different sizes and the same attributes, or where there are the predetermined number or more of symbols having the same attributes, for example, when the symbols are newly rearranged. Moreover, in this embodiment, as an example, a firework launch image is displayed as the predetermined effect image, and “star symbols” different from each other in color and size are used as the symbols to be rearranged after the predetermined effect image is displayed. The colors, sizes, number and the like of the star symbols are changed according to awards, payouts and the like. In other words, the star symbols are equivalent to so-called scatter symbols which enable the award to be paid by having a predetermined number of the scatter symbols at the time when rearrangement is finished.

This embodiment is also characterized in that the payout to the player is calculated according to the arrangement (combination) and the number of the star symbols having different sizes and colors, which are finally established. A combination of the symbols to be a bonus trigger may be determined to make a shift to a bonus game when the combination is established.

In the case where a combination accompanied by a payout is established by the symbols finally displayed in the respective display areas 28a to 28o, payout processing is executed according to a payout table to be described later (Steps S300 and S400). The above-mentioned basic game will be described in detail later with reference to the drawings.

In this embodiment, description will be hereinafter given of the case where the symbols are arranged in 5 cells in width×3 cells in height, a total of 15 cells included in the display area 28 (28a to 28o), respectively. However, the present invention is not limited to the display area 28 including 5 cells in width×3 cells in height.

Next, with reference to the perspective view shown in FIG. 2, description will be given of a configuration of a slot machine 10 according to the embodiment of the present invention. This slot machine 10 is placed in a game facility.

In the slot machine 10, coins, bills or valuable electronic information equivalent thereto are used as game media for executing the unit game. Note, however, that the game media are not particularly limited in this embodiment. For example, medals, tokens, electronic money and tickets can be cited. Moreover, payouts are also provided by the game media including coins, bills or valuable electronic information equivalent thereto. The tickets described above are not particularly limited. For example, bar-coded tickets as described later and the like can be cited.

As shown in FIG. 2, the slot machine 10 includes the cabinet 11, a top box 12 provided on the cabinet 11 and a main door 13 provided on the front surface of the cabinet 11.

Inside the cabinet 11, the liquid crystal display unit 17 is provided, which displays the firework launch image as the predetermined effect image, or which displays specific symbols by using each of or a plurality of 5 cells in width×3 cells in height (which may be simply described as 5×3 cells). The liquid crystal display unit 17 includes the display area 28 (28a to 28o) made up of 5×3 cells for displaying the symbols. When the basic game is executed, the predetermined effect image such as the firework launch image is displayed in the entire display area 28. Subsequently, star symbols are arranged by using each of or a plurality of the display areas 28a to 28o in the display area 28 made up of 5×3 cells.

In this embodiment, although the display area 28 (28a to 28o) made up of 5×3 cells included in the liquid crystal display unit 17 is cited as an example of a display, the display area 28 is not limited to 5×3 cells.

In front of the liquid crystal display unit 17 in the main door 13, a lower image-display-panel 16 (display) is provided. The lower image-display-panel 16 includes a transparent liquid crystal panel, and displays various information about games, effect images and the like during the games.

In the lower image-display-panel 16, a credit number display unit 31 and a payout number display unit 32 are provided. In the credit number display unit 31, the number of coins credited is displayed as an image. In the payout number display unit 32, the number of coins to be paid out when a combination of symbols arranged is a combination accompanied by a payout (hereinafter referred to as a winning combination) is displayed as an image.

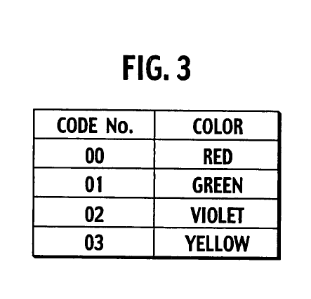

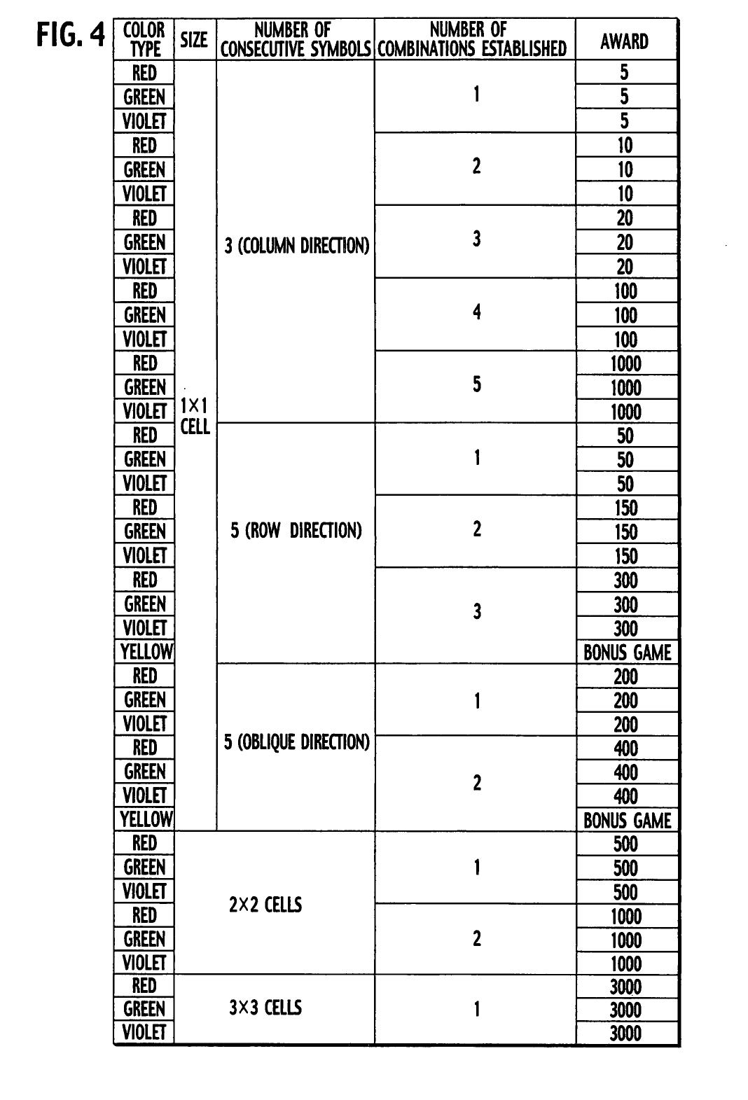

On the lower image-display-panel 16, the predetermined effect image, such as the firework launch image, is displayed in the entire display area 28, and the symbols are arranged in the display areas 28a to 28o. The star symbols arranged in the display areas 28a to 28o are prepared as symbol arrays to which code numbers “00” to “03” shown in FIG. 3 are imparted. As to the star symbols arranged in the display areas 28a to 28o, the number of the symbols adjacent to each other, sizes, colors and the like are as designated by combinations shown in FIG. 4. Moreover, awards (payouts) are also determined by the combinations shown in FIG. 4. On the lower image-display-panel 16, the star symbols are arranged in the respective display areas 28a to 28o after the predetermined effect image is displayed in the entire display area 28.

In the embodiment of the present invention, instead of not setting a line which yields a combination involved with a payout, that is, a so-called payline, payouts set in FIG. 4 are provided for the symbols arranged in the display areas 28a to 28o.

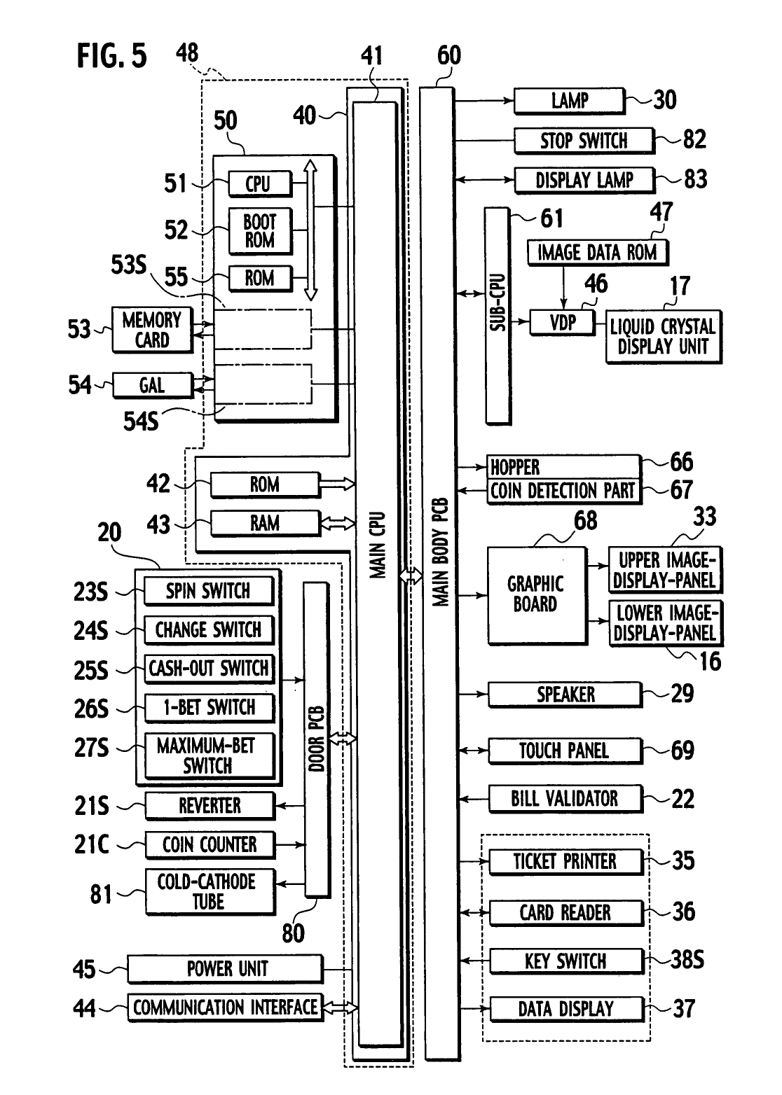

On a front surface of the lower image-display-panel 16, a touch panel 69 (see FIG. 5) is provided. The player can input various instructions by operating the touch panel 69.

Below the lower image-display-panel 16, provided are: a control panel 20 including a plurality of buttons 23 to 27 used by the player to input instructions related to a game process; the coin receiving opening 21 for receiving coins into the cabinet 11; and a bill validator 22.

In the control panel 20, a spin button 23, a change button 24, a cash-out button 25, a 1-BET button 26 and a maximum-BET button 27. The spin button 23 is a button for inputting an instruction to start scrolling the symbols displayed in the display area 28. The change button 24 is a button used to request money exchange to a staff member at the game facility. The cash-out button 25 is a button for inputting an instruction to pay out credited coins onto a coin tray 18.

The 1-BET button 26 is a button for inputting an instruction to bet one of the credited coins on a game. The maximum-BET button 27 is a button for inputting an instruction to bet, on the game, the maximum number (for example, 50) of coins that can be bet on one game out of the credited coins.

The bill validator 22 detects whether or not bills are legitimate, and accepts the legitimate bills into the cabinet 11. The bill validator 22 may be configured to be able to read a bar-coded ticket 39 to be described later. On a front surface of a lower part of the main door 13, in other words, below the control panel 20, a belly glass 34 is provided, on which characters and the like of the slot machine 10 are drawn.

On a front surface of the top box 12, an upper image-display-panel 33 is provided. The upper image-display-panel 33 includes a liquid crystal panel, and displays, for example, effect images and images representing introduction of game contents and description of game rules.

In the top box 12, a speaker 29 for audio output is provided. Below the upper image-display-panel 33, a ticket printer 35, a card reader 36, a data display 37 and a keypad 38 are provided.

The ticket printer 35 prints a bar-code on a ticket, the bar-code having coded data such as the total number of credits, the number of jackpot credits, time and date and an identification number of the slot machine 10, and outputs the ticket as the bar-coded ticket 39. The player can use the bar-coded ticket 39 to play other slot machines and to change the bar-coded ticket 39 for bills and the like at a cashier or the like in the game facility.

The card reader 36 reads data from a smart card, and writes data into the smart card. The smart card is a card carried by the player, and stores, for example, data for identifying the player and data on a history of games played by the player.

The data display 37 is formed of a fluorescent display or the like, and displays, for example, the data read by the card reader 36 and data inputted by the player using the keypad 38. The keypad 38 is used to input instructions or data for ticketing and the like.

FIG. 3 is an explanatory view showing an example of symbol arrays arranged in the respective display areas 28 (28a to 28o) provided in the liquid crystal display unit 17 provided in the cabinet 11. As shown in FIG. 3, a symbol array including a total of four symbols having the code numbers “00” to “03” is prepared. In each of the display areas 28 (28a to 28o), symbol arrays having symbols arranged in different orders from each other may be set. The colors of the symbols are not limited to the four colors shown in FIG. 3.

The symbols displayed in the respective display areas 28 (28a to 28o) include “RED”, “GREEN”, “VIOLET” and “ALLOW”. A winning combination formed when the symbols shown in FIG. 3 are aligned adjacent to each other, a payout, a bonus game and the like provided when the winning combination is established are set in a payout table shown in FIG. 4.

FIG. 4 shows an example of the payout table for providing the bonus game or other payouts. This payout table is referred to when a normal basic game is executed. In a case where symbols shown in the table of FIG. 4 are lined up with the symbols arranged in the display areas 28 (28a to 28o), corresponding payouts are provided according to the table shown in FIG. 4.

For example, when five consecutive red symbols, each having a 1×1 cell size, are displayed in any row direction, “50” payout credits are provided. Moreover, when three rows are formed, in each of which five consecutive yellow symbols, each having a 1×1 cell size, are displayed, in other words, when yellow star symbols are arranged in all 5×3 cells, the bonus game is provided. Although not shown in FIG. 4, a symbol which enables a jackpot payout to be provided may be prepared, and the jackpot payout may be executed when the jackpot symbol is arranged.

In the present invention, the bonus game is not particularly limited as long as the game is in a state advantageous to the player. The bonus game advantageous to the player is not particularly limited as long as the bonus game is more advantageous than the basic game. For example, a state where more game media can be won than the basic game, a state where the game media can be won at a higher probability than the basic game, a state where the number of the game media consumed is reduced compared with the basic game, and the like can be cited. To be more specific, as the bonus game, a free game, a second game and the like can be cited.

The symbols displayed (arranged) in the fifteen display areas 28 (28a to 28o), respectively, are switched to a display of the predetermined effect image such as the firework launch image, for example, when the spin button 23 is pressed after the 1-BET button 26 or the maximum-BET button 27 is pressed. After a predetermined time has passed since start of the display of the predetermined effect image in the entire display areas 28, the symbols are simultaneously or sequentially arranged in the respective display areas. This is called rearrangement. In this event, the symbol designated by any of the code numbers in the symbol array shown in FIG. 3 is arranged in each of the display areas 28 (28a to 28o). Moreover, the symbols to be arranged are previously set according to the payout table shown in FIG. 4, and the payout is provided according to the payout table shown in FIG. 4. When a bonus game trigger is established, in other words, when the ‘YELLOW’ star symbols are arranged in all the display areas 28 in this embodiment, the game state is shifted from a basic game state to a bonus game state.

FIG. 5 is a block diagram showing a control circuit in the slot machine 10 shown in FIG. 2. As shown in FIG. 5, the control circuit includes components such as a controller 48, a main body PCB (Printed Circuit Board) 60, a sub-CPU 61, a door PCB 80 and various switches and sensors. The controller 48 is formed of a mother board 40 and a gaming board 50.

The gaming board 50 includes: a CPU (Central Processing Unit) 51, a ROM 55 and a boot ROM 52, which are connected to each other through an internal bus; a card slot 53S compatible with a memory card 53; and an IC socket 54S compatible with a GAL (Generic Array Logic) 54.

The memory card 53 stores game programs and game system programs. The game programs include a stop symbol determination program. The stop symbol determination program is a program for determining symbols (code numbers corresponding to the symbols) to be arranged in the respective display areas 28 (28a to 28o). The stop symbol determination program contains symbol weighted data corresponding to each of various payout rates (for example, 80%, 84% and 88%). The symbol weighted data is data showing a corresponding relationship between the code number of each symbol (see FIG. 3) and one or more random numbers belonging to a predetermined numeric range (0 to 256) for each of the display areas 28 (28a to 28o).

The payout rate is set according to payout rate setting data outputted from the GAL 54. According to the symbol weighted data corresponding to the payout rate, stop symbols are determined.

The card slot 53S is formed so as to enable the memory card 53 to be inserted thereinto or removed therefrom, and is connected to the mother board 40 through an IDE bus. Thus, the kinds and contents of games played by use of the slot machine 10 can be changed by removing the memory card 53 from the card slot 53S, writing another game program and game system program into the memory card 53 and inserting the memory card 53 into the card slot 53S.

The game program contains a program related to a game process and a program for making a shift to the bonus game. Moreover, the game program contains image data and sound data which are outputted during games. Furthermore, the game program contains image data and sound data as notification data for notifying to the player when a chain reaction game is started by taking procedures to be described later.

The GAL 54 includes a plurality of input ports and output ports. Upon receipt of data through the input port, the GAL 54 outputs data corresponding to the inputted data from the output port. The data outputted from the output port is the payout rate setting data described above.

The IC socket 54S is formed so as to enable the GAL 54 to be attached thereto or detached therefrom, and is connected to the mother board 40 through a PCI bus. Thus, the payout rate setting data to be outputted from the GAL 54 can be changed by detaching the GAL 54 from the IC socket 54S, rewriting programs stored in the GAL 54 and attaching the GAL 54 to the IC socket 54S.

The CPU 51, the ROM 55 and the boot ROM 52, which are connected to each other through the internal bus, are connected to the mother board 40 through a PCI bus. The PCI bus transmits signals between the mother board 40 and the gaming board 50, and also supplies power from the mother board 40 to the gaming board 50. The ROM 55 stores country identification information and an authentication program. The boot ROM 52 stores a preliminary authentication program, a program (a boot code) for the CPU 51 to run the preliminary authentication program, and the like.

The authentication program is a program (alteration check program) for authenticating the game program and the game system program. In other words, the authentication program is a program for checking and proving that the game program and the game system program have not been altered. Specifically, the authentication program is described according to procedures for authenticating the game program and the game system program. The preliminary authentication program is a program for authenticating the authentication program described above. Moreover, the preliminary authentication program is described according to procedures for proving that the authentication program to be authenticated has not been altered, in other words, for authenticating the authentication program.

The mother board 40 includes a main CPU 41, a ROM (Read Only Memory) 42, a RAM (Random Access Memory) 43 and a communication interface 44.

The main CPU 41 includes a function as a controller for controlling the entire slot machine 10. Particularly, the main CPU 41 performs: control of outputting to the sub-CPU 61 a command signal to display the predetermined effect image such as the firework launch image, for example, in the entire display area 28 of the liquid crystal display unit 17 when credits are bet and the spin button 23 is pressed; control of determining symbols to be arranged after the predetermined effect image is displayed in the display area 28; and control of arranging the determined symbols.

After the predetermined effect image is displayed on the display (the liquid crystal display unit 17), the main CPU 41 determines symbols to be newly rearranged by selecting the symbols from a plurality of star symbols having different attributes, and arranges the determined symbols. Moreover, when newly rearranging the symbols after the predetermined effect image is displayed on the display (the liquid crystal display unit 17), the main CPU 41 executes the processing of sequentially displaying the determined symbols in the plurality of display areas in an arbitrary order. In this event, the already arranged symbols are blinked. Furthermore, while blinking the arranged symbols, the main CPU 41 executes control of changing the attributes of the symbols when originally displayed to different attributes. For example, first, the red star symbols are stop-displayed, and the symbols are changed to the yellow star symbols and displayed while sequentially displaying the other symbols.

The main CPU 41 cumulatively stores, in the slot machine 10, a part of the credits to be paid to the player as jackpot credits in the RAM 43. Moreover, when the number of the credits has become a predetermined jackpot threshold (for example, “500”) or more, the main CPU 41 determines whether or not the cumulatively stored jackpot credits are to be paid out. When a winning combination accompanied by a jackpot payout is established on the display areas 28f to 28i, the main CPU 41 provides the payout of the jackpot credits.

In a stand-alone slot machine such as the slot machine 10, the jackpot credits are stored in the RAM 43. On the other hand, in the case of a slot machine compatible with a progressive system in which a plurality of slot machines and a management server are connected to each other, a part of credits paid to a player in each of the slot machines is stored in the management server, and the credits are paid out from the management server to the slot machine that meets predetermined conditions.

In basic game execution processing, the main CPU 41 determines the symbols to be arranged in the respective display areas 28 (28a to 28o) after displaying the predetermined effect image, and outputs a stop command signal for the determined symbols to a graphic board 68. The graphic board 68 controls the lower image-display-panel 16 according to the stop command signal. Under the control of the graphic board 68, the determined symbols are stop-displayed on the lower image-display-panel 16.

When all the symbols are arranged on the display (the liquid crystal display unit 17) under the control of the graphic board 68, the main CPU 41 makes a determination according to the payout table and executes the following control. Specifically, a corresponding payout is provided when there are a predetermined number or more of symbols having different sizes and the same attributes, or when there are a predetermined number or more of symbols having the same attributes.

Specifically, in the slot machine 10 described as the embodiment of the present invention, when a game is started by betting the coins and pressing the spin button 23, the kinds of symbols to be rearranged in the display areas 28a to 28o are determined by the main CPU 41 after the predetermined effect image such as the firework launch image is displayed. Thereafter, the symbols having different sizes and the symbols having different colors are stop-displayed. In this event, every time the symbols are sequentially rearranged in arbitrary display areas, the already displayed symbols are blinked and rearranged. In this blinking, the kind of the symbols is sometimes changed to the kind different from that of the symbols originally displayed. Subsequently, when all the symbols are finally arranged, an award is provided according to the kind, the size and the number of the symbols.

The ROM 42 stores a program such as a BIOS (Basic Input/Output System) executed by the main CPU 41, and also stores data to be permanently used. When the BIOS is executed by the main CPU 41, each peripheral device is initialized. Moreover, read processing through the gaming board 50 is started for the game program and the game system program which are stored in the memory card 53. The ROM 42 is also used as a memory for storing payout table corresponding to the predetermined number or more of the symbols having different sizes and the same attributes or the predetermined number or more of symbols having the same attributes when the symbols are arranged on the display.

The main CPU 41 determines whether or not the symbols arranged on the display are set in a payout table stored in the ROM 42.

The RAM 43 stores data and programs used when the main CPU 41 performs processing. In a case where the slot machine 10 is a so-called stand-alone slot machine, the RAM 43 stores the number of jackpot credits.

The communication interface 44 is for communication with a host computer and the like provided in the game facility through a communication line.

The main body PCB (Printed Circuit Board) 60 and the door PCB 80, which will be described later, are connected to the mother board 40 through USBs (Universal Serial Bus), respectively. A power unit 45 is connected to the mother board 40. When power is supplied from the power unit 45 to the mother board 40, the main CPU 41 in the mother board 40 is started. Moreover, the power is supplied to the gaming board 50 through the PCI bus to start the CPU 51.

The controller 48 includes the respective configurations of the mother board 40 and the gaming board 50 described above. The controller 48 can execute the following arrangement control. Specifically, after a plurality of symbols arranged on the lower image-display-panel 16 are scrolled, symbols to be arranged are determined by selecting the symbols from the plurality of symbols having different sizes and different attributes, and the determined symbols are arranged. Thereafter, the determined symbols are sequentially displayed in the display areas of the lower image-display-panel 16 in an arbitrary order. Moreover, the already arranged symbols are blinked. Furthermore, during the blinking, the attributes of the symbols when originally displayed are changed to different attributes. When the symbols are arranged on the lower image-display-panel 16, the controller 48 determines whether or not the arranged symbols form an arrangement accompanied by the payout stored in the ROM 42. Thereafter, the controller 48 executes control of making a corresponding payout for the predetermined number or more of symbols in the display areas.

A device or an apparatus which generates an input signal to be inputted to the main CPU 41 and a device or an apparatus having operations controlled by a control signal outputted from the main CPU 41 are connected to the main body PCB 60 and the door PCB 80. The main CPU 41 performs arithmetic processing by executing the game program and the game system program, which are stored in the RAM 43, with the input signal inputted to the main CPU 41, and stores results thereof in the RAM 43. The main CPU 41 also performs the processing of transmitting the control signal to the respective devices or apparatuses as control processing for the respective devices or apparatuses.

A lamp 30, the sub-CPU 61, a hopper 66, a coin detection part 67, the graphic board 68, the speaker 29, the touch panel 69, the bill validator 22, the ticket printer 35, the card reader 36, a key switch 38S and the data display 37 are connected to the main body PCB 60. Moreover, a stop switch 82 and a display lamp 83 provided so as to correspond to the stop switch 82 are connected to the main body PCB 60.

The lamp 30 is controlled to be turned on and off in accordance with a control signal outputted from the main CPU 41.

The sub-CPU 61 performs control of scrolling the symbols in the respective display areas 28 (28a to 28o) set in the liquid crystal display unit 17, and is connected to a VDP (Video Display Processor) 46.

The VDP 46 reads image data of the symbols stored in an image data ROM 47, generates a scroll image to be displayed on the liquid crystal display unit 17, and outputs the scroll image to the liquid crystal display unit 17.

The hopper 66 is placed in the cabinet 11, and pays out a predetermined number of coins from a coin payout port 19 onto the coin tray 18 with a control signal outputted from the main CPU 41. The coin detection part 67 is provided inside the coin payout port 19, and outputs an input signal to the main CPU 41 when detecting that the predetermined number of coins are paid out from the coin payout port 19.

The graphic board 68 controls display of images other than the symbols displayed in the display area 28 on the upper and lower image-display-panels 33 and 16 with a control signal outputted from the main CPU 41. The credit number display unit 31 in the lower image-display-panel 16 displays the number of credits stored in the RAM 43. Moreover, the payout number display unit 32 in the lower image-display-panel 16 displays the number of coins to be paid out. The graphic board 68 includes a VDP which generates image data with a control signal outputted from the main CPU 41, a video RAM which temporarily stores the image data generated by the VDP and the like.

The bill validator 22 reads images of bills, and accepts legitimate bills into the cabinet 11. Upon acceptance of the legitimate bills, the bill validator 22 outputs an input signal to the main CPU 41 according to an amount of the bills. Thereafter, the main CPU 41 stores, in the RAM 43, the number of credits corresponding to the amount of the bills transmitted by the input signal.

The ticket printer 35 prints a bar-code on a ticket with a control signal outputted from the main CPU 41, the bar-code having coded data such as the number of credits stored in the RAM 43, time and date and the identification number of the slot machine 10, and outputs the ticket as the bar-coded ticket 39.

The card reader 36 reads data from a smart card to transmit the data to the main CPU 41, and also writes data into the smart card with a control signal from the main CPU 41. The key switch 38S is provided in the keypad 38, and outputs an input signal to the main CPU 41 when the keypad 38 is operated by the player.

With a control signal outputted from the main CPU 41, the data display 37 displays the data read by the card reader 36 and the data inputted by the player using the keypad 38.

The control panel 20, a reverter 21S, a coin counter 21C and a cold-cathode tube 81 are connected to the door PCB 80. In the control panel 20, a spin switch 23S corresponding to the spin button 23, a change switch 24S corresponding to the change button 24, a cash-out switch 25S corresponding to the cash-out button 25, a 1-BET switch 26S corresponding to the 1-BET button 26 and a maximum-BET switch 27S corresponding to the maximum-BET button 27 are provided. Each of the switches 23S to 27S outputs an input signal to the main CPU 41 when the corresponding buttons 23 to 27 are operated by the player.

The coin counter 21C is provided inside the coin receiving opening 21, and discriminates whether or not coins thrown into the coin receiving opening 21 by the player are legitimate. Those other than the legitimate coins are discharged from the coin payout port 19. Upon detection of the legitimate coins, the coin counter 21C outputs an input signal to the main CPU 41.

The reverter 21S is operated with a control signal outputted from the main CPU 41, and allocates the coins recognized as the legitimate coins by the coin counter 21C to any one of a cash box (not shown) provided in the slot machine 10 and the hopper 66. Specifically, when the hopper 66 is filled with coins, the legitimate coins are allocated to the cash box by the reverter 21S. Meanwhile, when the hopper 66 is not filled with coins, the legitimate coins are allocated to the hopper 66.

The cold-cathode tube 81 functions as a backlight provided on a back side of the upper and lower image-display-panels 33 and 16, and is lighted with a control signal outputted from the main CPU 41.

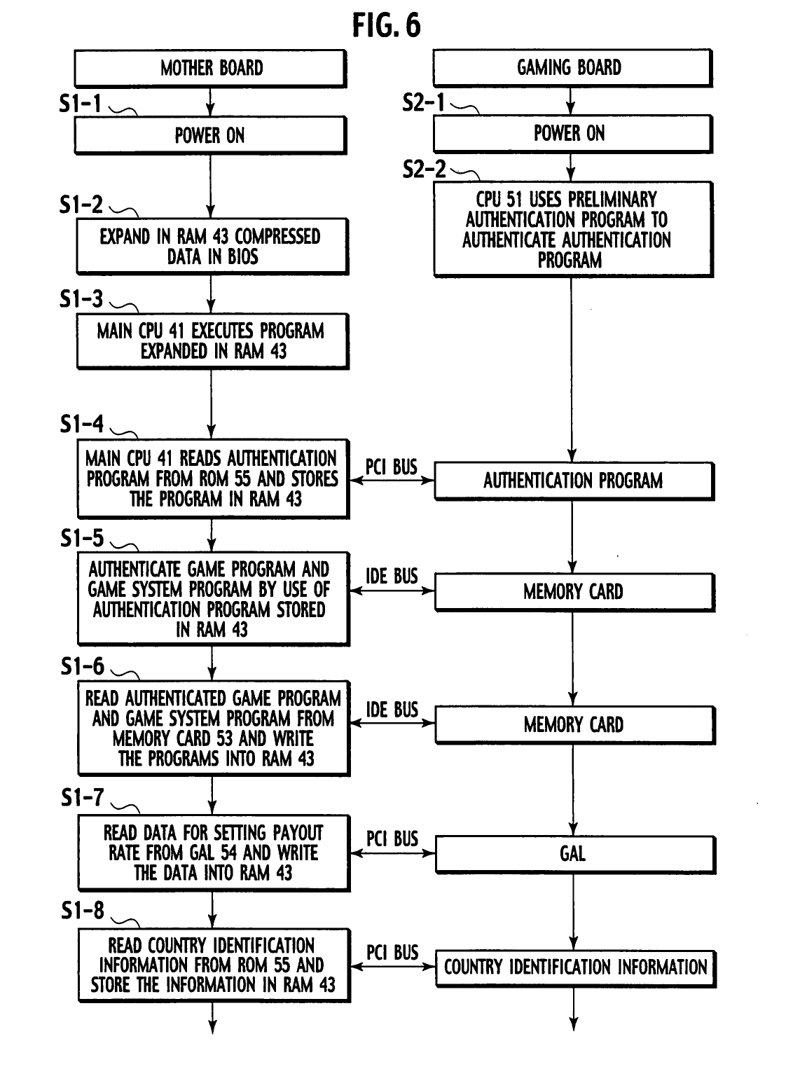

Next, specific processing executed in the slot machine 10 will be described. FIG. 6 is a flowchart showing procedures (the processing of Step S100 shown in FIG. 1) of authentication and read processing for the game program and the game system program executed by the mother board 40 and the gaming board 50 which are shown in FIG. 5. The memory card 53 is inserted into the card slot 53S in the gaming board 50, and the GAL 54 is attached to the IC socket 54S therein.

First, when a power switch is turned on in the power unit 45, the mother board 40 and the gaming board 50 are activated (Steps S1-1 and S2-1). When the mother board 40 and the gaming board 50 are activated, different processings are performed in parallel with each other. Specifically, in the gaming board 50, the CPU 51 reads a preliminary authentication program stored in the boot ROM 52, and performs, according to the read preliminary authentication program, preliminary authentication of previously checking and proving that an authentication program has not been altered before the program is taken into the mother board 40 (Step S2-2).

Meanwhile, in the mother board 40, the main CPU 41 executes a BIOS stored in the ROM 42 and expands compressed data, which is included in the BIOS, in the RAM 43 (Step S1-2). Thereafter, the main CPU 41 diagnoses and initializes various peripheral devices by executing the BIOS expanded in the RAM 43 (Step S1-3).

Subsequently, since the ROM 55 in the gaming board 50 is connected to the main CPU 41 through the PCI bus, the main CPU 41 reads an authentication program stored in the ROM 55. Furthermore, the main CPU 41 performs the processing of storing the read authentication program in the RAM 43 (Step S1-4).

Next, the main CPU 41 accesses the memory card 53 attached to the card slot 53S through the IDE bus. Thereafter, the main CPU 41 reads a game program and a game system program which are stored in the memory card 53.

Next, according to an authentication program stored in the RAM 43, the main CPU 41 performs authentication of checking and proving that the read game program and game system program have not been altered (Step S1-5).

When the above authentication processing is normally finished, the main CPU 41 stores the authenticated game program and game system program in the RAM 43 (Step S1-6). Next, the main CPU 41 accesses the GAL 54 attached to the IC socket 54S through the PCI bus, reads payout rate setting data from the GAL 54, and stores the data in the RAM 43 (Step S1-7). Thereafter, the main CPU 41 reads country identification information stored in the ROM 55 in the gaming board 50 through the PCI bus, and stores the read country identification information in the RAM 43 (Step S1-8).

After carrying out the above processing, the main CPU 41 conducts a basic game described below by sequentially reading and executing the game program and the game system program.

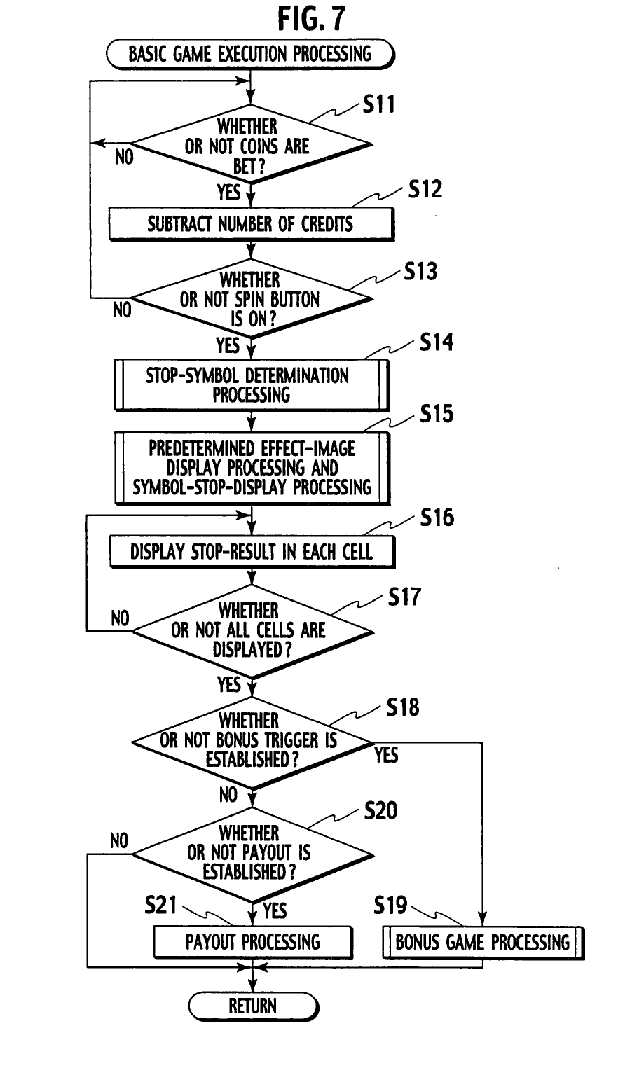

After the authentication and read processing shown in FIG. 6 is executed, the main CPU 41 performs the processing of executing the basic game. FIG. 7 is a flowchart showing specific procedures for basic game execution the processing of Step S200 shown in FIG. 1.

In the basic game execution processing, first, the main CPU 41 determines whether or not coins are bet (Step S11). In this processing, the main CPU 41 determines whether or not an input signal outputted from the 1-BET switch 26S when the 1-BET button 26 is pressed or an input signal outputted from the maximum-BET switch 27S when the maximum-BET button 27 is pressed is received. When it is determined that no coins are bet, the processing returns to Step S11.

Meanwhile, when it is determined in Step S11 that the coins are bet, the main CPU 41 performs the processing of reducing the number of credits stored in the RAM 43 according to the number of the coins bet (Step S12). When the number of the coins bet is larger than the number of credits stored in the RAM 43, the processing returns to Step S11 without performing the processing of reducing the number of credits stored in the RAM 43. When the number of the coins bet exceeds an upper limit (50 in this embodiment) that can be bet in one game, the processing advances to Step S13 without performing the processing of reducing the number of credits stored in the RAM 43. In this state, a predetermined effect image such as a firework launch image, for example, can be displayed in the entire display area 28.

Next, the main CPU 41 determines whether or not the spin button 23 is turned on (Step S13). In this processing, the main CPU 41 determines whether or not an input signal outputted from the spin switch 23S when the spin button 23 is turned on is received. When it is determined that the spin button 23 is not turned on, the processing returns to Step S11. In a case where the spin button 23 is not turned on (for example, a case where an instruction to finish the game is inputted without turning on the spin button 23), the main CPU 41 cancels a result of reduction in Step S12.

In this embodiment, description will be given of a case where, after the coins are bet (Step S11), the processing of reducing the number of credits (Step S12) is executed before it is determined whether or not the spin button 23 is turned on (Step S13). However, the present invention is not limited to the above example. For example, the present invention may also be applied to a case where, after the coins are bet (Step S1), it is determined whether or not the spin button 23 is turned on (Step S13), and, when it is determined that the spin button 23 is turned on (YES in Step S13), the processing of reducing the number of credits (Step S12) is executed.

Subsequently, when it is determined that the spin button 23 is turned on, the main CPU 41 performs stop symbol determination processing (Step S14). In the stop symbol determination processing, the main CPU 41 executes scroll display control processing for symbols by executing a stop symbol determination program stored in the RAM 43 (Step S15), and determines symbols to be displayed at the time of stop in the respective display areas 28 (28a to 28o).

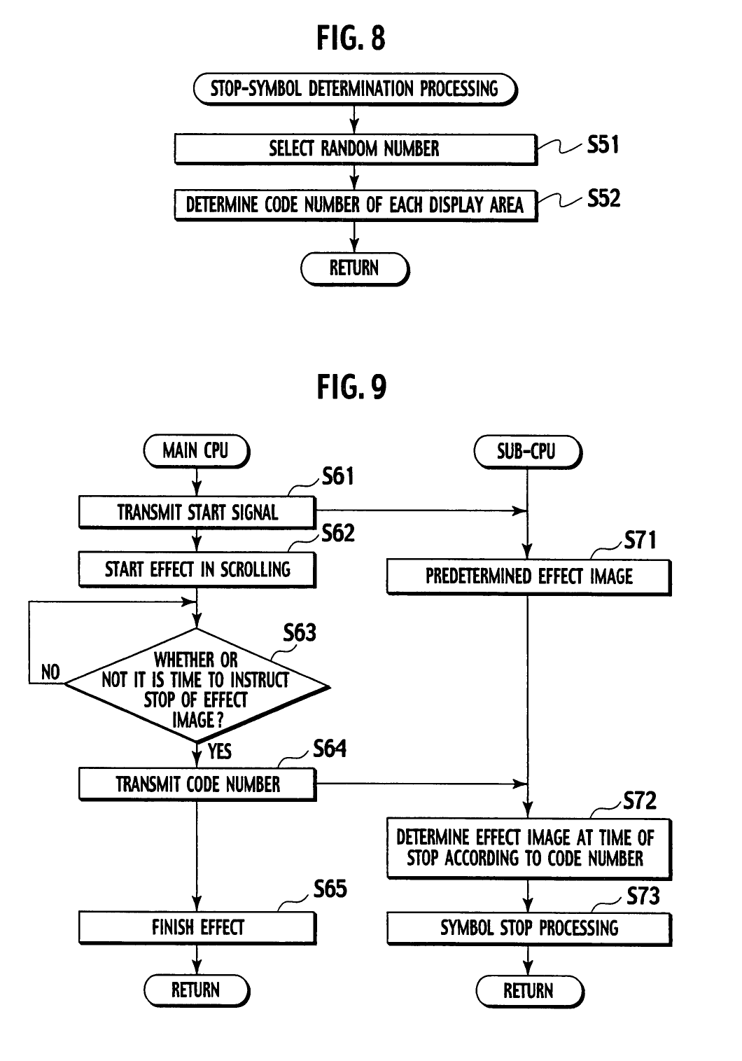

Next, the main CPU 41 performs the processing of displaying the predetermined effect image (Step S15). This processing is the processing of arranging the symbols determined in Step S14 in the respective display areas 28 (28a to 28o) after the predetermined effect image is displayed in the entire display areas 28 (28a to 28o). The stop symbol determination processing will be described with reference to FIG. 8. Moreover, the processing of displaying the predetermined effect image and of stop-displaying the symbols will be described with reference to FIG. 9.

Next, the main CPU 41 sequentially displays stop results, which are obtained by the processing of displaying the predetermined effect image and of stop-displaying the symbols, in an arbitrary order for each of the display areas (cells) (Step S16).

Subsequently, it is determined whether or not display of the symbols in all the display areas is completed (Step S17). When the display is completed (YES in Step S17), the main CPU 41 determines whether or not a bonus trigger is established (Step S18). When a bonus trigger set in the payout table shown in FIG. 4 is established (YES in Step S18), the processing shifts to bonus game processing (Step S19).

When the bonus trigger is not established (NO in Step S18), it is determined whether or not another payout shown in FIG. 4 is established (Step S20). When the payout is established (YES in Step S20), the processing shifts to payout processing to calculate corresponding payout credits (Step S21). In a case where a part of the credits to be paid out is saved, the main CPU 41 adds a predetermined number of credits to the number of credits stored in the RAM 43. When the credits are to be paid out, the main CPU 41 transmits a control signal to the hopper 66 to pay out a predetermined number of credits. In this event, the coin detection part 67 counts the number of coins to be paid out from the hopper 66, and transmits a payout completion signal to the main CPU 41 when the counted number reaches a designated number. Thus, the main CPU 41 stops driving of the hopper 66 and finishes the coin payout processing.

Meanwhile, when a combination accompanied by a payout is not established (NO in Step S20), in other words, when the player loses the game, no credits are to be paid out. Thus, the basic game is executed as described above.

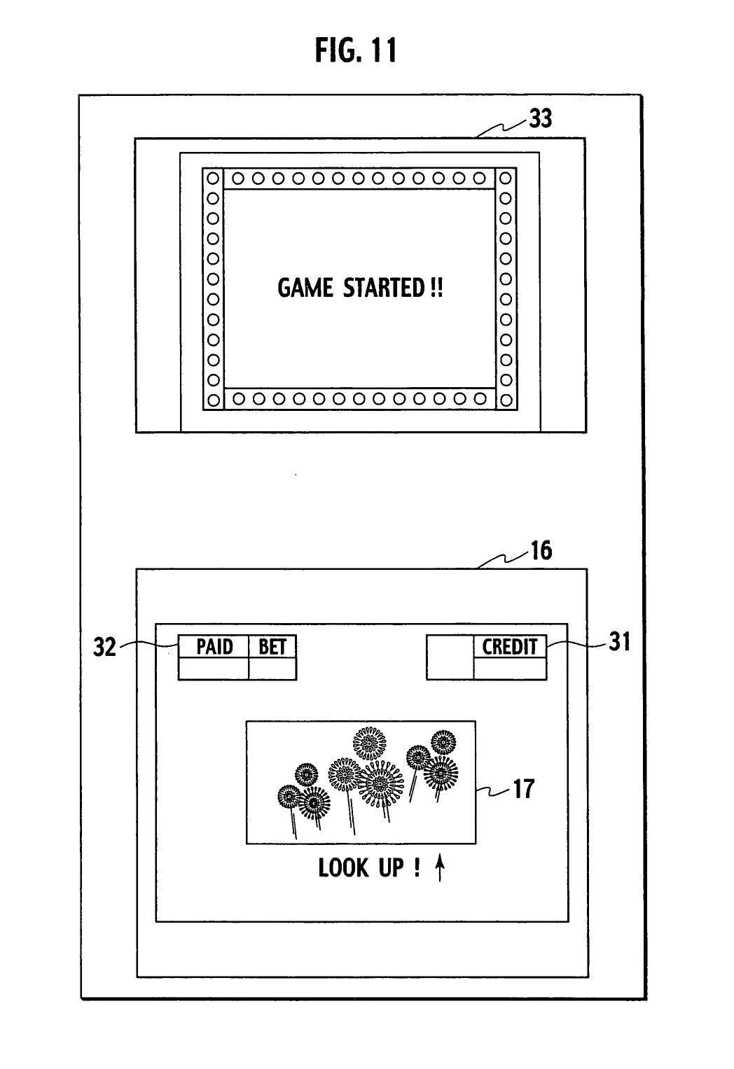

The basic game in the embodiment of the present invention, the processing of which is shown in FIG. 7, will be specifically described with reference to FIGS. 11 to 18. 5 cells in width×3 cells in height shown in each of FIGS. 12 to 18 correspond to the respective display areas 28 (28a to 28o) in the liquid crystal display unit 17 shown in FIG. 2. For convenience, R, G, V and Y, which are initial letters of “RED”, “GREEN”, “VIOLET” and “YELLOW”, are appended in the respective cells to express colors of symbols in the cells.

When the spin button 23 is pressed in a state where a desired number of credits are bet by the player throwing coins into the coin receiving opening 21 or the like, display of a predetermined effect image such as a firework launch image, for example, is started in the entire display area 28 of the liquid crystal display unit 17 provided on the front surface of the cabinet 11. FIG. 11 shows a display example of notifying that the basic game is to be started in the slot machine 10. As shown in FIG. 11, the firework launch image is displayed in the display area 28 (the liquid crystal display unit 17).

The main CPU 41 determines symbols to be stop-displayed in the respective display areas 28 (28a to 28o) by executing the stop symbol determination processing. Thereafter, by control processing for the display of the predetermined effect image and the stop-display of the symbols by the main CPU 41, the symbols are stopped (rearranged) in 5×3 cells, a total of 15 cells of the display area 28 (28a to 28o), respectively. Accordingly, stop results of the determined symbols are sequentially displayed in an arbitrary order for each of the display areas (cells) by the main CPU 41.

FIG. 12 shows a display example after a predetermined time has passed since start of the stop-display. In this display example, “RED” is stop-displayed in the display area 28c, “GREEN” is stop-displayed in the display area 28d, “GREEN” is stop-displayed in the display area 28f, “VIOLET” is stop-displayed in the display area 28j, “GREEN” is stop-displayed in the display area 28l, and “GREEN” is stop-displayed in the display area 28n. In this embodiment, while the already arranged symbols are blinked, first attributes (colors) of the symbols at the time when originally arranged may be changed to second attributes (colors).

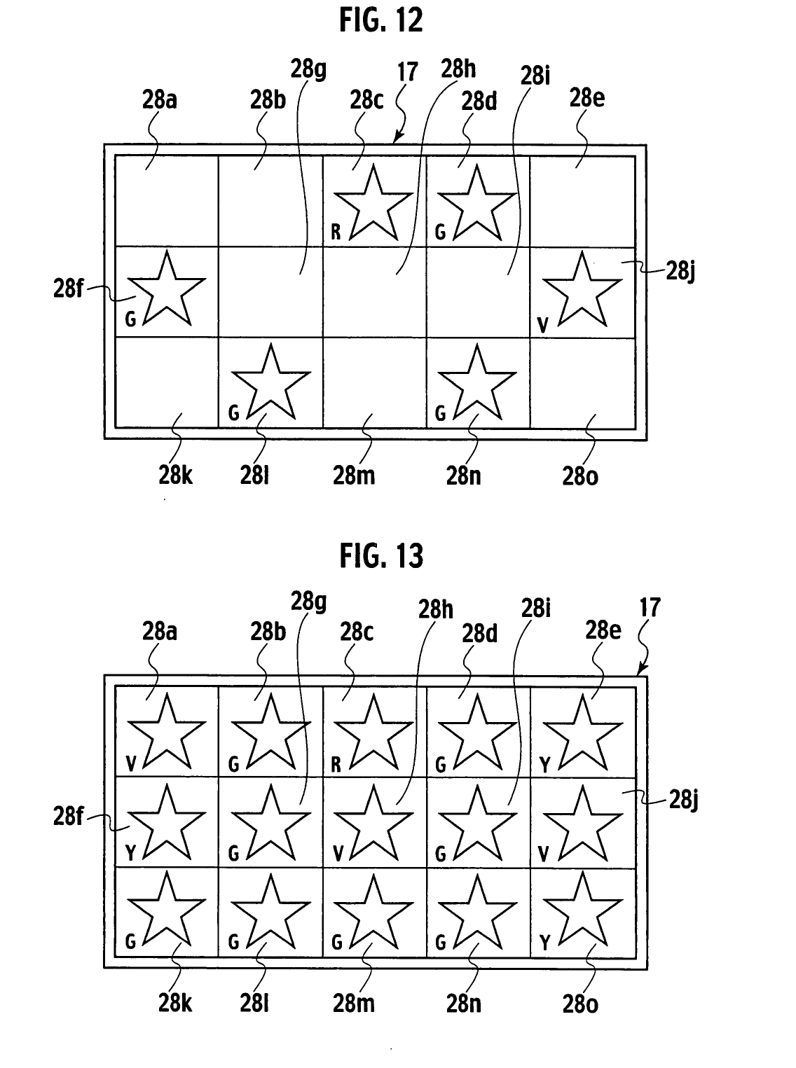

After the time has further passed, for example, in the case of a display example shown in FIG. 13, two combinations are established, each of which includes three vertically consecutive “GREEN” star symbols, each having a 1×1 cell size. In this event, “10” payout credits are provided.

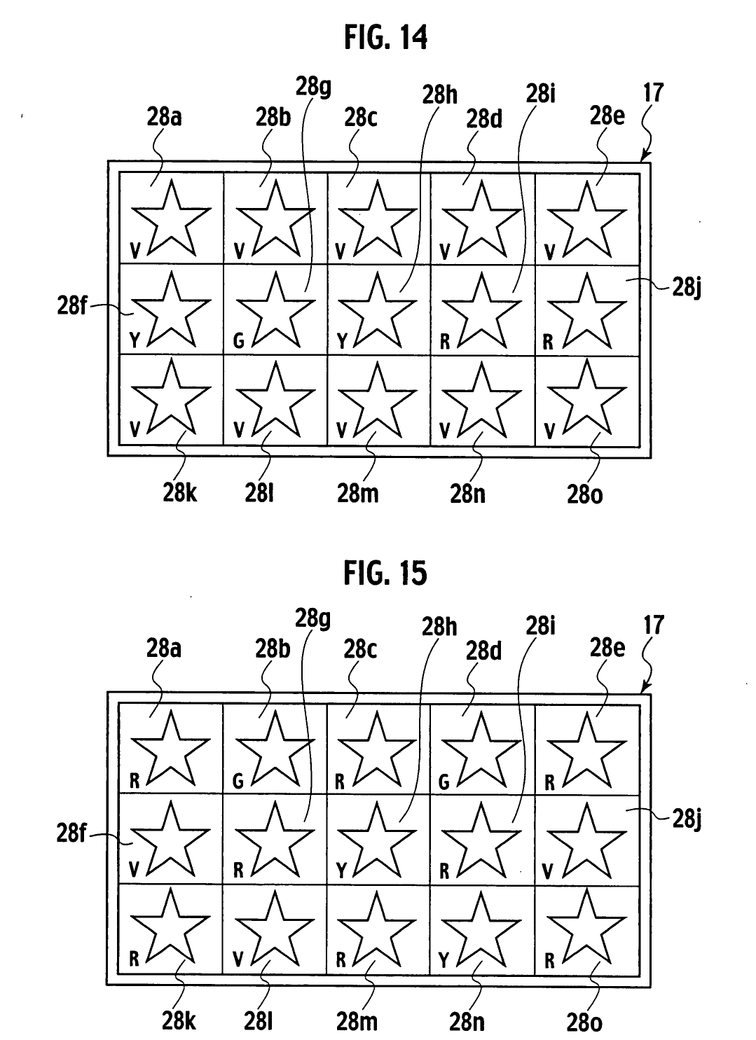

FIGS. 14 to 18 show examples of combinations accompanied by payouts. In a display example shown in FIG. 14, two combinations are established, each of which includes in a row direction five consecutive “VIOLET” star symbols, each having a 1×1 cell size. In this event, “300” payout credits are provided. In a display example shown in FIG. 15, two combinations are established, each of which includes in an oblique direction five consecutive “RED” star symbols, each having a 1×1 cell size. In this event, “400” payout credits are provided.

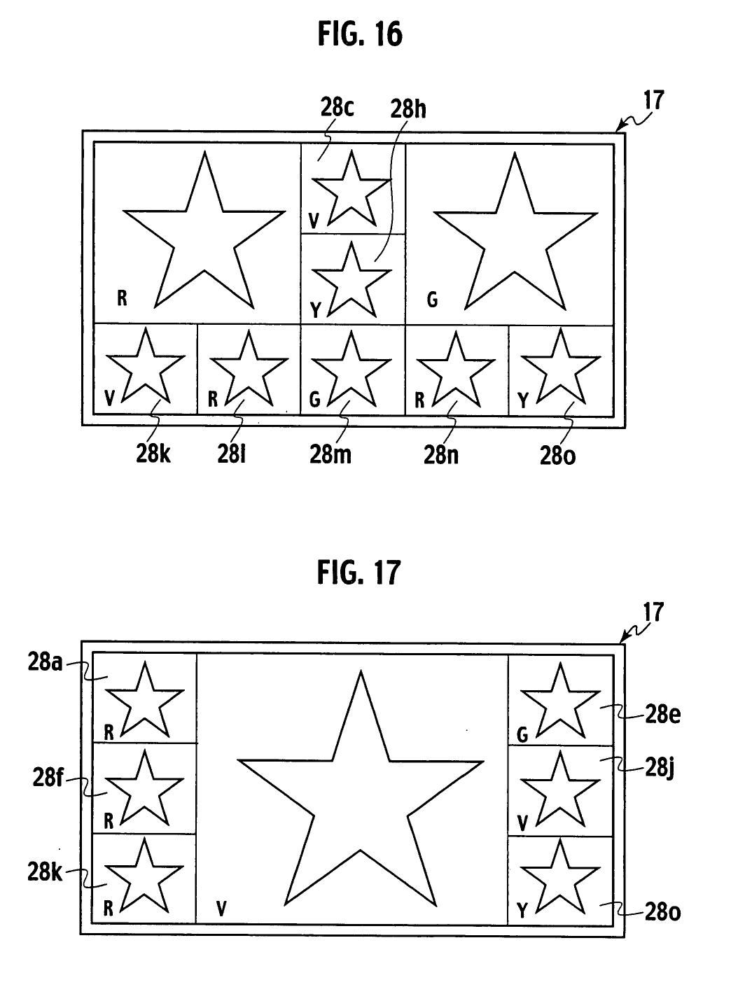

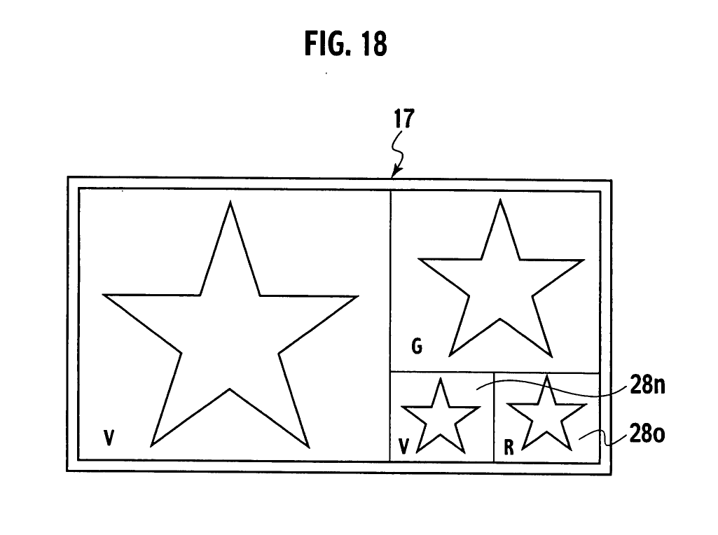

In a display example shown in FIG. 16, one “RED” star symbol having a 2×2 cell size is displayed by using the display areas 28a, 28b, 28f and 28g, and one “GREEN” star symbol having a 2×2 cell size is displayed by using the display areas 28d, 28e, 28i and 28j. In this event, “1000” payout credits are provided. In a display example shown in FIG. 17, one “VIOLET” star symbol having a 3×3 cell size is displayed by using the display areas 28b, 28c, 28d, 28g, 28h, 28i, 28l, 28m and 28n, and a combination including in a column direction three consecutive “RED” star symbols, each having a 1×1 cell size, is established. In this event, “3005” payout credits are provided. In a display example shown in FIG. 18, one “VIOLET” star symbol having a 3×3 cell size is displayed by using the display areas 28a, 28b, 28c, 28f, 28g, 28h, 28k, 28l and 28m, and one “GREEN” star symbol having a 2×2 cell size is displayed by using the display areas 28d, 28e, 28i and 28j. In this event, “3500” payout credits are provided.

As described above, in the slot machine 10 described as the embodiment of the present invention, when the basic game is executed, the predetermined effect image is displayed in the liquid crystal display unit 17. Thereafter, symbols to be arranged are determined by selecting the symbols from a plurality of symbols having different attributes, and the determined symbols are stop-displayed. When the symbols are displayed on the display, a corresponding payout is provided for the symbols forming a combination accompanied by a payout. When the determined symbols are stop-displayed, the determined symbols are sequentially displayed in an arbitrary order in the display area. Specifically, unlike the conventional case, the symbols are not changed all at once but changed while shifting the timing. Consequently, in the course of rearrangement of the symbols, a symbol or a combination including a plurality of symbols, which is accompanied by a payout, is gradually formed by the symbols sequentially stop-displayed. Thus, the player can have higher expectations for an award. The star symbols at the time when stop-displayed include symbols having different sizes, such as 2×2 cell display and 3×3 cell display. Thus, the expectations of the player can be heightened. It is also possible to provide higher awards according to not only the display size described above but also a high award symbol, differences in time for which display is continued, and the like. Accordingly, the expectations of the player can be further heightened.

As described above, according to the slot machine 10 described as the embodiment of the present invention, awards can be generated on the conditions different from those of the conventional payline. Moreover, the player can be allowed to have higher expectations by imparting new entertainment properties to the conditions of generating the awards.

Each of the tables shown in FIGS. 3 and 4 described in this embodiment is an example, and the present invention is not limited thereto. Moreover, each of the display examples of the basic game described with reference to FIGS. 11 to 18 is also an example, and the present invention is not limited thereto.

FIG. 8 is a flowchart showing the stop control processing for the symbols, which is described in Step S14 in FIG. 7. This processing is performed by the main CPU 41 executing the stop symbol determination program stored in the RAM 43.

First, the main CPU 41 selects random numbers corresponding to the respective display areas 28 (28a to 28o) from a numeric range of 0 to 255 by executing a random number generation program included in the stop symbol determination program (Step S51).

Next, the main CPU 41 determines the code numbers (see FIG. 3) of the symbols to be arranged in 5×3 cells, a total of 15 cells in the display area 28, respectively, according to five random numbers selected by referring to symbol weighted data corresponding to the payout rate setting data outputted from the GAL 54 and stored in the RAM 43 (Step S52). Thereafter, the main CPU 41 determines the symbols to be arranged in the display areas 28a to 28o by determining the code numbers of the respective display areas 28. For example, in the display example shown in FIG. 13, among the respective display areas 28 (28a to 28o), the code number of the symbol displayed in the display area 28a is determined to be “02”, the code number of the symbol displayed in the display area 28b is determined to be “01”, the code number of the symbol displayed in the display area 28c is determined to be “00”, the code number of the symbol displayed in the display area 28d is determined to be “01”, the code number of the symbol displayed in the display area 28e is determined to be “03”, the code number of the symbol displayed in the display area 28f is determined to be “03”, the code number of the symbol displayed in the display area 28g is determined to be “01”, the code number of the symbol displayed in the display area 28h is determined to be “02”, the code number of the symbol displayed in the display area 28i is determined to be “01”, the code number of the symbol displayed in the display area 28j is determined to be “02”, the code number of the symbol displayed in the display area 28k is determined to be “01”, the code number of the symbol displayed in the display area 28l is determined to be “01”, the code number of the symbol displayed in the display area 28m is determined to be “01”, the code number of the symbol displayed in the display area 28n is determined to be “01”, and the code number of the symbol displayed in the display area 28o is determined to be “03”. Accordingly, the number of payout credits is determined to be 10.

FIG. 9 is a flowchart showing the processing for display of the predetermined effect image and for the symbol scroll-display and the symbol stop control processing, which are described in Step S18 in FIG. 8. This processing is executed between the main CPU 41 and the sub-CPU 61.

First, the main CPU 41 transmits to the sub-CPU 61 a start signal to start scroll display of the symbols in the display area 28 of the liquid crystal display unit 17 (Step S61). Upon receipt of the start signal from the main CPU 41, the sub-CPU 61 outputs a command to display the predetermined effect image to the VDP 46. Thereafter, the VDP 46 reads symbol image data stored in the image data ROM 47, and displays a firework launch image or the like, for example, as the predetermined effect image (Step S71).

After transmitting the start signal to the sub-CPU 61 in Step S61, the main CPU 41 executes effect of the predetermined effect image (Step S62). This processing is the processing of displaying images on the lower image-display-panel 16, outputting sounds from the speaker 29, and the like for a period of time (for example, 3 seconds) determined according to a result of the stop symbol determination processing (Step S14 in FIG. 7) and the like.

Next, the main CPU 41 determines whether or not it is time to instruct stop of the predetermined effect image (Step S63 in FIG. 9).

When it is determined in the processing of Step S63 that it is not the time to instruct stop of the predetermined effect image, the processing returns to Step S63, and the display of the predetermined effect image is continued. On the other hand, when it is determined in the processing of Step S63 that it is the time to instruct stop of the predetermined effect image, the main CPU 41 transmits the code numbers of the symbols stored in the RAM 43 to the sub-CPU 61 (Step S64). Upon receipt of the code numbers of the symbols from the main CPU 41, the sub-CPU 61 determines the symbols to be arranged so as to correspond to the code numbers (Step S72).

Thereafter, the processing of stopping the predetermined effect image is performed, and the symbols are arranged in the respective display areas 28 (Step S73). Moreover, the processing of displaying the effect image by the main CPU 41 is finished (Step S65).

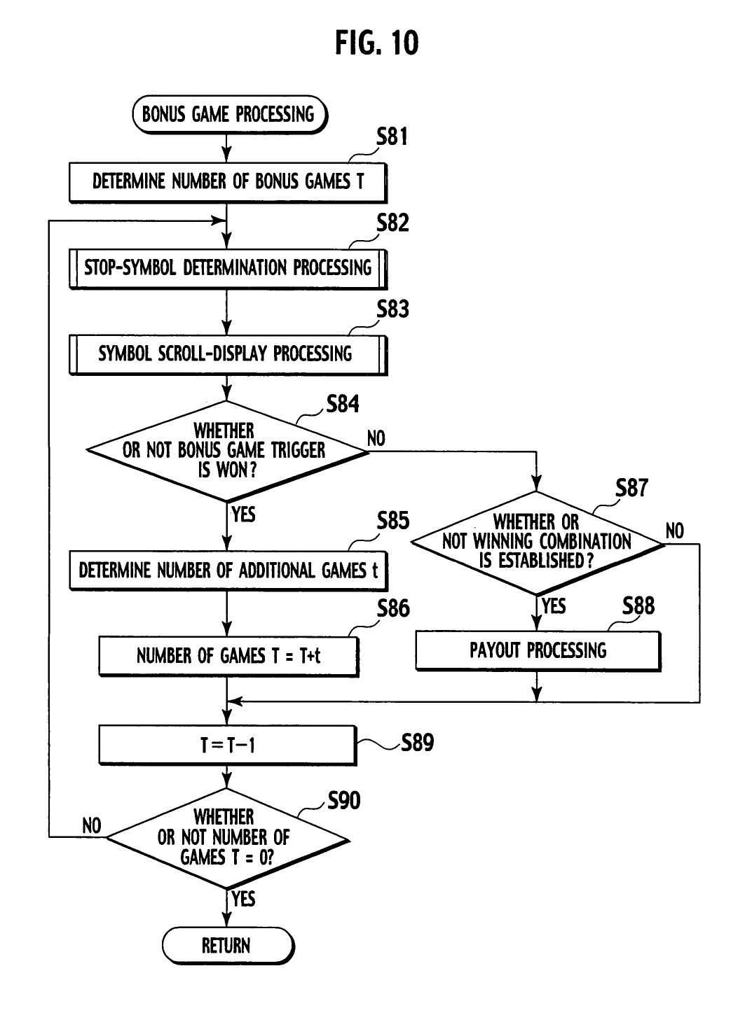

FIG. 10 is a flowchart showing the bonus game processing described in Step S19 in FIG. 7.

In the bonus game processing, first, the main CPU 41 determines the number of times T of executing the bonus game between 10 to 25 games according to the random numbers obtained by executing the random number generation program included in the stop symbol determination program stored in the RAM 43 (Step S81). Thereafter, the main CPU 41 stores data on the determined number T of bonus games in the RAM 43.

Next, the main CPU 41 executes stop symbol determination processing (Step S82) and symbol scroll-display processing (Step S83). The processing of Step S82 is approximately the same as that described with reference to FIG. 8. The processing of Step S83 is approximately the same as that described with reference to FIG. 9. Since these processings have already been described above, description thereof will be omitted here.

Next, in FIG. 10, the main CPU 41 determines whether or not a bonus game trigger is established, in other words, whether or not three yellow star symbols, each having a 1×1 cell size, are aligned in the row direction (Step S84). When it is determined that the bonus game trigger is established (YES in Step S84), the number of times t of repeating the bonus game is newly determined (Step S85). Thereafter, the determined number t of repetitions is added to the current number T of bonus games (Step S86). Thus, when the player wins another bonus game during the bonus game, the number of remaining bonus games is increased.

When the bonus game trigger is not established, the main CPU 41 determines whether or not a winning combination is established (Step S87). When it is determined that the winning combination is established (YES in Step S87), the main CPU 41 executes a payout of coins corresponding to the number of coins thrown in and the winning combination (Step S88). In this event, the payout is provided according to the payout table shown in FIG. 4.

When the processing of Step S86 or S88 is executed, or when it is determined in Step S87 that no winning combination is established (when it is determined that the player loses the game), the main CPU 41 reads the number T of bonus games stored in the RAM 43, and subtracts 1 from the value of the read number T of games. Thereafter, the number T of games after subtraction is stored again in the RAM 43 (Step S89).

Subsequently, the main CPU 41 determines whether or not the number T of bonus games reaches the number of times determined in Step S81 (Step S90). To be more specific, the determination is made according to whether or not the number T of games stored in the RAM 43 is set to 0. When the number T of games is not 0, in other words, when it is determined that the number of times of executing the bonus game does not reach the number of times determined in Step S81, the processing returns to Step S82, and the above processing is repeated.

On the other hand, when the number T of games is 0, in other words, when it is determined that the number of times of executing the bonus game reaches the number of times determined in Step S81, the processing is finished. Thus, the bonus game is executed.

Although the slot machine according to the embodiment of the present invention has been described above, the concrete examples are merely illustrated, and are not intended to particularly limit the present invention. The specific configurations of the respective means and the like can be appropriately changed in design. The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein. Moreover, the effects described in the embodiment of the present invention are only a list of optimum effects achieved by the present invention. Therefore, the effects of the present invention are not limited to those described in the embodiment of the present invention.

What is claimed is:

1. A slot machine comprising:
a display adapted to arrange a plurality of symbols having different sizes and different attributes; and
a controller configured to
(a) determine symbols to be arranged on the display from the plurality of symbols,
(b) arrange the determined symbols on the display, and
(c) provide a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

2. The slot machine according to claim 1, wherein, in arrangement of the plurality of symbols, the controller is configured to sequentially arrange the determined symbols in an arbitrary order in a display area of the display.

3. The slot machine according to claim 1, wherein, in arrangement of the plurality of symbols, the controller is configured to
sequentially arrange the determined symbols in an arbitrary order in a display area of the display, and
blink the already arranged symbols.

4. The slot machine according to claim 1, wherein, in arrangement of the plurality of symbols, the controller is configured to
sequentially arrange the determined symbols in an arbitrary order in a plurality of display areas of the display,
blink the already arranged symbols, and
change the attributes of the already-arranged symbols from first attributes originally arranged to second attributes during the blinking.

5. The slot machine according to claim 1, further comprising:
a memory storing a payout table corresponding to any one of the predetermined number or more of the symbols identical in attribute and the predetermined number or more of the symbols different in size and identical in attribute,
wherein the controller is configured to
determine whether arrangement of the symbols is one corresponding to the payout table stored in the memory when the predetermined number of the determined symbols are arranged on the display, and
provide the payout corresponding to the predetermined number or more of the symbols when it is determined that the arrangement of the symbols is the one corresponding to the payout table stored in the memory.

6. A slot machine comprising:
a display adapted to arrange a plurality of symbols having different sizes and different attributes; and
a controller configured to
(a) determine symbols to be arranged on the display from the plurality of symbols,
(b) sequentially arrange the determined symbols in an arbitrary order in a display area of the display, and
(c) provide a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

7. The slot machine according to claim 6, wherein, in arrangement of the plurality of symbols, the controller is configured to sequentially arrange the determined symbols in the arbitrary order in the display area of the display, and to blink the already arranged symbols.

8. The slot machine according to claim 6, wherein, in arrangement of the plurality of symbols, the controller is configured to
sequentially arrange the determined symbols in the arbitrary order in a plurality of display areas of the display,
blink the already arranged symbols, and
change the attributes of the already-arranged symbols from first attributes originally arranged to second attributes during the blinking.

9. The slot machine according to claim 6, further comprising:
a memory storing a payout table corresponding to any one of the predetermined number or more of the symbols identical in attribute and the predetermined number or more of the symbols different in size and identical in attribute,
wherein the controller is configured to
determine whether arrangement of the symbols is one corresponding to the payout table stored in the memory when the predetermined number of the determined symbols are arranged on the display, and
provide the payout corresponding to the predetermined number or more of the symbols when it is determined that the arrangement of the symbols is the one corresponding to the payout table stored in the memory.

10. A slot machine comprising:
a display adapted to arrange a plurality of symbols having different sizes and different attributes;
a memory storing a payout table corresponding to any one of a predetermined number or more of the symbols identical in attribute and a predetermined number or more of the symbols different in size and identical in attribute; and
a controller configured to
(a) determine symbols to be arranged on the display from the plurality of symbols,
(b) sequentially arrange the determined symbols in an arbitrary order in a display area of the display,
(c) blink the already arranged symbols,
(d) change the attributes of the already-arranged symbols from first attributes originally arranged to second attributes during the blinking,
(e) determine whether arrangement of the symbols is one corresponding to the payout table stored in the memory when a predetermined number of the determined symbols are arranged on the display, and
(f) provide the payout corresponding to the predetermined number or more of the symbols when it is determined that the arrangement of the symbols is the one corresponding to the payout table stored in the memory.

11. A method of playing a slot machine, the method comprising the steps of
(a) arranging symbols determined from a plurality of symbols on a display adapted to arrange the plurality of symbols having different sizes and different attributes; and
(b) providing a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

12. The method of playing a slot machine according to claim 11, wherein the arrangement step includes the step of sequentially arranging the determined symbols in an arbitrary order in a display area of the display in arrangement of the plurality of symbols.

13. The method of playing a slot machine according to claim 11, wherein the arrangement step includes the steps of
sequentially arranging the determined symbols in an arbitrary order in a display area of the display in arrangement of the plurality of symbols, and
blinking the already arranged symbols.

14. The method of playing a slot machine according to claim 11, wherein the arrangement step includes the steps of
sequentially arranging the determined symbols in an arbitrary order in a plurality of display areas of the display in arrangement of the plurality of symbols,
blinking the already arranged symbols, and
changing the attributes of the already-arranged symbols from first attributes originally arranged to second attributes during the blinking.

15. The method of playing a slot machine according to claim 11, further comprising the step of
storing in a memory a payout table corresponding to any one of the predetermined number or more of the symbols identical in attribute and the predetermined number or more of the symbols different in size and identical in attribute, wherein
the payout providing step includes the steps of
determining whether arrangement of the symbols is one corresponding to the payout table stored in the memory when the predetermined number of the determined symbols are arranged on the display, and
providing the payout corresponding to the predetermined number or more of the symbols when it is determined that the arrangement of the symbols is the one corresponding to the payout table stored in the memory.

16. A method for playing a slot machine, the method comprising the steps of.
(a) sequentially arranging, in an arbitrary order, symbols determined from a plurality of symbols in a display area of a display adapted to arrange the plurality of symbols having different sizes and different attributes; and
(b) providing a payout corresponding to a predetermined number or more of symbols in any one of a case where there are the predetermined number or more of the symbols identical in attribute, and a case where there are the predetermined number or more of the symbols different in size and identical in attribute, when a predetermined number of the determined symbols are arranged on the display.

17. The method of playing a slot machine according to claim 16, wherein the arrangement step includes the steps of
sequentially arranging the determined symbols in the arbitrary order in the display area of the display in arrangement of the plurality of symbols, and
blinking the already arranged symbols.

18. The method of playing a slot machine according to claim 16, wherein the arrangement step includes the steps of
sequentially arranging the determined symbols in the arbitrary order in a plurality of display areas of the display in arrangement of the plurality of symbols,
blinking the already arranged symbols, and
changing the attributes of the already arranged symbols from first attributes originally arranged to second attributes during the blinking.

19. The method of playing a slot machine according to claim 16, further comprising the step of
storing in a memory a payout table corresponding to any one of the predetermined number or more of the symbols identical in attribute and the predetermined number or more of the symbols different in size and identical in attribute, wherein
the payout providing step includes the steps of
determining whether arrangement of the symbols is one corresponding to the payout table stored in the memory when the predetermined number of the determined symbols are arranged on the display, and
providing the payout corresponding to the predetermined number or more of the symbols when it is determined that the arrangement of the symbols is the one corresponding to the payout table stored in the memory.

20. A method of playing a slot machine, the method comprising the steps of
(a) sequentially arranging, in an arbitrary order, symbols determined from a plurality of symbols in a display area of a display adapted to arrange the plurality of symbols having different sizes and different attributes;
(b) blinking the already arranged symbols;
(c) changing the attributes of the already-arranged symbols from first attributes originally arranged to second attributes during the blinking;
(d) determining whether arrangement of the symbols is one corresponding to a payout table stored in a memory, which stores payouts corresponding to any one of a predetermined number or more of symbols identical in attribute and a predetermined number or more of symbols different in size and identical in attribute, when a predetermined number of the determined symbols are arranged on the display; and
(e) providing the payout corresponding to the predetermined number or more of the symbols when it is determined that the arrangement of the symbols is the one corresponding to the payout table stored in the memory.
